(19) United States
(12) Patent Application Publication
(10) Pub. No.: US 2017/0123411 A1
(43) Pub. Date: May 4, 2017

(54) METHOD FOR ANALYZING VARIATION CAUSES OF MANUFACTURING PROCESS AND SYSTEM FOR ANALYZING VARIATION CAUSES OF MANUFACTURING PROCESS

(71) Applicant: Industrial Technology Research Institute, Hsinchu (TW)

(72) Inventors: Kuang-Hung Cheng, Tainan City (TW); Chi-Chun Hsia, Kaohsiung City (TW); Yi-Lin Chiang, Tainan City (TW)

(21) Appl. No.: 14/979,537

(22) Filed: Dec. 28, 2015

(30) Foreign Application Priority Data
Nov. 3, 2015 (TW) 104136155

(51) Int. Cl. G05B 19/418; G06N 7/00; G06N 99/00

(52) U.S. Cl. CPC G05B 19/41875; G06N 99/005; G06N 7/005; G05B 2219/33034; G05B 2219/32368; G05B 2219/40335

(57) ABSTRACT

A method for analyzing variation causes of manufacturing process is applied. The method includes acquiring manufacturing process data of a plurality of products, and using at least one of a non-probability based classifier and a probability based classifier to compute manufacturing process data to acquire a contribution rate of each of the manufacturing process parameters. The method further includes determining whether a classifier accuracy rate is greater than a threshold. The method further includes, if yes, performing a deleting operation to delete a manufacturing process parameter having a lowest contribution rate and using the at least one of the non-probability based classifier and the probability based classifier to compute the manufacturing process data again; and if no, setting the manufacturing process parameters not deleted by the deleting operation plus the manufacturing process parameter deleted in the last deleting operation as the at least one crucial manufacturing process parameter.

### CROSS-REFERENCE TO RELATED APPLICATION

This application claims the priority benefit of Taiwan application no. 104136155, filed on Nov. 3, 2015. The entirety of the above-mentioned patent application is hereby incorporated by reference herein and made a part of this specification.

### TECHNICAL FIELD

The present disclosure relates to a method for analyzing variation causes of manufacturing process and a system for analyzing variation causes of manufacturing process.

### BACKGROUND

In manufacturing industry, a course of processing raw materials into products is known as a manufacturing process. As manufacturable products become more diverse and meticulous with continuous development of technologies, manufacturing processes also become far more complex, resulting in more of adjustable manufacturing process parameters. The environment of manufacturing site also includes various factors causing variations on manufacturing process conditions. For example, environment factors such as temperature and humidity may be different everyday. Accordingly, when mechanical apparatuses have been operated for a long period of time, difficulties in maintaining stable manufacturing process conditions may be increased by variation factors including shifts in physical and chemical features, component and source of the raw material, as well as proficiency and experience of operators. When the manufacturing process conditions are unstable or variations occur, the products are usually prone to defects.

For long, engineers at the manufacturing site have always hoped to identify the cause of defect as soon as possible when dealing with the defective products, so that the manufacturing process may be adjusted to resume normal production. Traditionally, analysis on the cause of the defect at the manufacturing site aims to identify the crucial manufacturing parameter causing the defect by manually analyzing records (e.g., control parameters, measure parameters and the like in various manufacturing processes) kept during operations of various mechanical apparatuses, or records (e.g., task records, operating records, etc.) kept during manual operations. Such method is highly dependent on experiences of senior operators. As the manufacturing process conditions grow more complex each day, it will still take quite a long time, even for the senior operators, to identify the cause while more defective goods are still being made at the same time.

Therefore, a variety of techniques for analyzing variation causes of manufacturing process have been developed to automatically analyze a large amounts of data kept during the manufacturing process. As such, the crucial manufacturing parameters can quickly be identified to facilitate the engineers to fix the problems in time, so as to resume the normal production and minimize the loss caused by the defects.

However, some of the existing techniques for analyzing variations causes of manufacturing process are still restricted by data types, whereas some others failed to analyze contribution level of each crucial parameter. More importantly, when the techniques are introduced to the manufacturing site, there are still rooms for improvement since it is quite often that information regarding the manufacturing process parameters cannot be fully provided due to manpower, resource and cost considerations, which leads to errors on the analysis.

### SUMMARY

The present disclosure provides a method for analyzing variation causes of manufacturing process and a system for analyzing variation causes of manufacturing process, which are capable of performing a numerical coding on non-numeric data and selecting at least one crucial manufacturing process parameter causing defective products by using a classifier.

One exemplary embodiment of the present disclosure provides a method for analyzing variation causes of manufacturing process, which includes acquiring manufacturing process data of a plurality of products, wherein the manufacturing process data comprises a plurality of manufacturing process parameters and a product quality parameter corresponding to the products. The method further includes using at least one of a non-probability based classifier and a probability based classifier to compute manufacturing process data to acquire a contribution rate of each of the manufacturing process parameters. The method further includes determining whether a classifier accuracy rate is greater than a threshold. The method further includes if the classifier accuracy rate is greater than the threshold, performing a deleting operation on the manufacturing process parameters to delete the manufacturing process parameter having the lowest contribution rate, and using the at least one of the non-probability based classifier and the probability based classifier to compute the manufacturing process data again in order to acquire the contribution rate of each of the manufacturing process parameters; and setting at least one of the manufacturing process parameters as at least one crucial manufacturing process parameter if the classifier accuracy rate is not greater than the threshold.

The present disclosure provides a system for analyzing variation causes of manufacturing process, which includes a collecting module, an evaluation module, a determination module and a comparison module. The collecting module is configured to acquire manufacturing process data of a plurality of products, wherein the manufacturing process data comprises a plurality of manufacturing process parameters and a product quality parameter corresponding to the products. The valuation module is configured to use at least one of a non-probability based classifier and a probability based classifier to compute the manufacturing process data in order to acquire a contribution rate of each of the manufacturing process parameters. The determination module is configured to determine whether a classifier accuracy rate is greater than a threshold. If the classifier accuracy rate is greater than the threshold, the comparison module performs a deleting operation on the manufacturing process parameters to delete the manufacturing process parameter having the lowest contribution rate, and uses the at least one of the non-probability based classifier and the probability based classifier to compute the manufacturing process data again in order to acquire the contribution rate of each of the manufacturing process parameters. If the classifier accuracy rate is not greater than the threshold, the comparison module sets at least one of the manufacturing process parameters as at least one crucial manufacturing process parameter.

Based on the above, in the method for analyzing variation causes of manufacturing process and the system for analyzing variation causes of manufacturing process according to the present disclosure, the non-probability based classifier and the probability based classifier are used to compute the manufacturing process data in order to acquire the contribution rate of the manufacturing process parameter, and the manufacturing process parameter having the low contribution rate is deleted when the classifier accuracy rate is greater than the threshold in order to obtain the crucial manufacturing process parameters.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a flowchart illustrating an example of a metalworking manufacturing process according to the present disclosure.

FIG. 2 is a block diagram illustrating a system for analyzing variation causes of manufacturing process according to an exemplary embodiment of the present disclosure.

FIG. 3 is a flowchart illustrating an optimal labeling method according to an exemplary embodiment of the present disclosure.

FIG. 4 illustrates a classifier having a variable selection structure according to an exemplary embodiment of the present disclosure.

FIG. 5 illustrates a classifier having a variable selection structure according to an exemplary embodiment of the present disclosure.

FIG. 6 is a flowchart illustrating a probability model method according to an exemplary embodiment of the present disclosure.

FIG. 7 is a flowchart illustrating a method for analyzing variation causes of manufacturing process according to an exemplary embodiment of the present disclosure.

### DETAILED DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

During a manufacturing process, after raw materials are fed to production apparatuses, various processes are sequentially performed at different manufacturing stages on a schedule, and sensing signal values processed at a specific manufacturing process stage and control values set by a manufacturing process control system at the same time will be kept. The fed raw materials will be gradually processed into a final product. The raw materials at each of the manufacturing process stages may be referred to as a work in process (WIP). At the manufacturing process stages, values of parameters of each processing performed on the work in process may be sensed by a sensor and recorded as manufacturing process parameters (e.g., temperature, pressure, etc.). It should be noted that, on each product (i.e., the final product produced after all the manufacturing process stages are completed), each block may correspond to the sensed values recorded while processing through each of the manufacturing process stages. However, in a quality assurance stage, a quality check is usually performed on the entire product to determine whether the entire product is defective and a quality check result thereof is recorded as quality measure data corresponding to the product. The analysis method and system of the present disclosure are capable of analyzing the manufacturing process parameters and product quality parameters in order to identify a major cause causing the defective product.

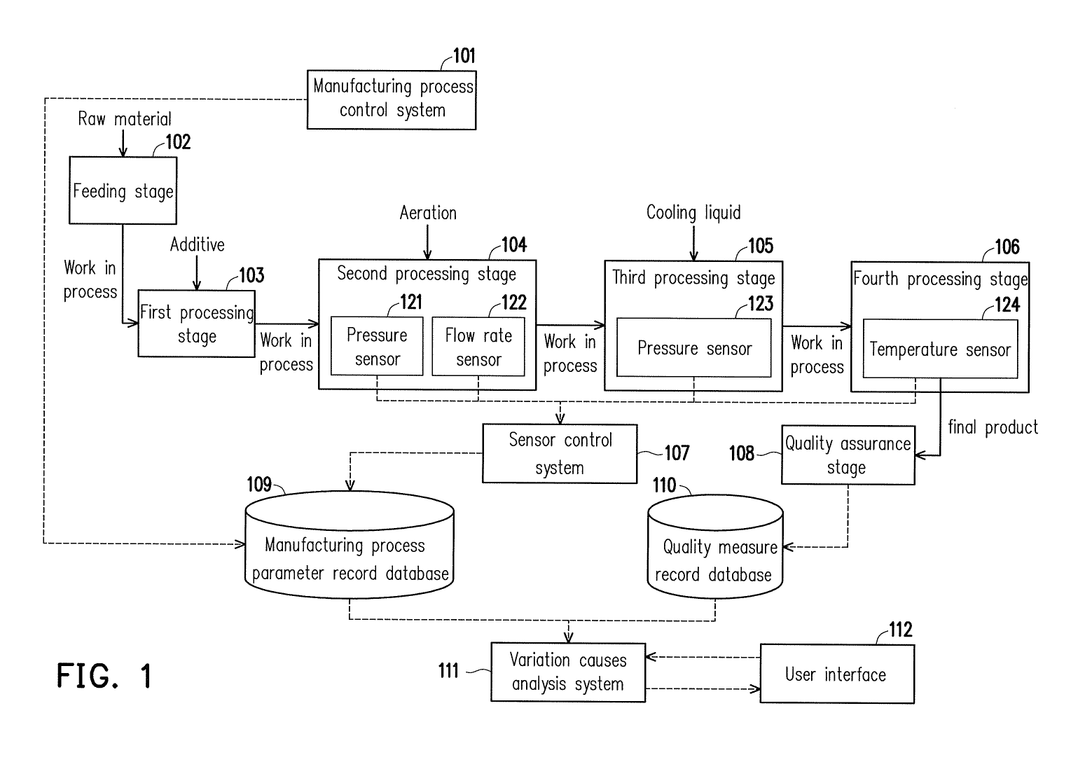

FIG. 1 is a flowchart illustrating an example of a metalworking manufacturing process according to the present disclosure.

Referring to FIG. 1, after entering a feeding stage 102, a raw material will then go through four processing stages to be processed into a final product. The raw material is known as a work in process during the manufacturing process. It should be noted that, in FIG. 1, solid line arrows represent a raw material flow and dashed line arrows represent an information flow.

When the work in process enters a first processing stage 103, a manufacturing process control system 101 controls a type of an additive and records the type of the additive in a manufacturing process parameter record database 109. Next, when the work in process enters a second processing stage 104, the manufacturing process control system 101 performs an aeration to maintain stability of the manufacturing process and records a pressure and a flow rate of the aeration respectively by a pressure sensor 121 and a flow rate sensor 122. Next, when the work in process enters a third processing stage 105, the manufacturing process control system 101 introduces a cooling liquid and records a pressure of the cooling liquid by a pressure sensor 123. Thereafter, when the work in process the enters a fourth processing stage 106 to be processed into the final product, a temperature of the final product is sensed and recorded by a temperature sensor 124.

The values sensed by the pressure sensor 121, the flow rate sensor 122, the pressure sensor 123 and the temperature sensor 124 are collected by a sensor control system 107 and recorded in the manufacturing process parameter record database 109 in order to generate manufacturing process parameters corresponding to the final product. Each block (e.g., 10 cm) per one final product (e.g., several meters) may correspond to the sensed values recorded while processing through each of the processing stages. However, in a quality assurance stage 108, a quality check is performed on the entire product and then a quality check result is recorded in a quality measure record database 110 in order to generate quality measure data corresponding to the final product. In the end, a variation cause analysis system 111 may analyze the manufacturing process parameters and the quality measure data according to the manufacturing process parameter record database 109 and the quality measure record database 110 in order to identify a major cause causing the defective product and display the same on a user interface 112. It should be noted that, the system and method for analyzing variation causes of manufacturing process are not limited only to be suitable for the example of the metalworking manufacturing process depicted in FIG. 1.

### First Exemplary Embodiment

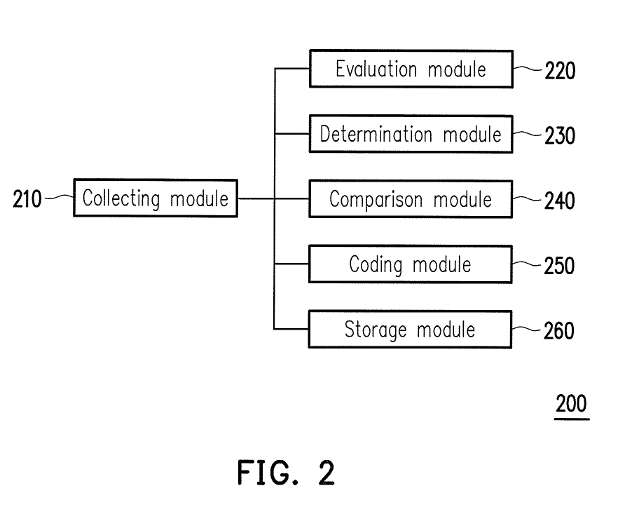

FIG. 2 is a block diagram illustrating a system for analyzing variation causes of manufacturing process according to an exemplary embodiment of the present disclosure.

Referring to FIG. 2, a manufacturing process variation cause analysis system 200 includes a collecting module 210, an evaluation module 220, a determination module 230, a comparison module 240 and a coding module 250.

The collecting module 210 is configured to acquire manufacturing process data of a plurality of products. Herein, each of the products includes a plurality of blocks, and the manufacturing process data includes, for example, a plurality of manufacturing process parameters corresponding to each of the blocks and a product quality parameter corresponding to each of the products.

Format of the manufacturing process data and description thereof are provided as follows:

$$\begin{matrix}{x}_{1 , 1}^{( 1 )} , {x}_{1 , 1}^{( 2 )} , … , {x}_{1 , 1}^{( p )} , {y}_{1 , 1} \\ {x}_{1 , 2}^{( 1 )} , {x}_{1 , 2}^{( 2 )} , … , {x}_{1 , 2}^{( p )} , {y}_{1 , 2} \\ ⋯ \\ {x}_{1 , m 1}^{( 1 )} , {x}_{1 , m 1}^{( 2 )} , … , {x}_{1 , m 1}^{( p )} , {y}_{1 , m 1}\end{matrix} \} {Z}_{1} \\ … \\ \begin{matrix}{x}_{n , 1}^{( 1 )} , {x}_{n , 1}^{( 2 )} , … , {x}_{n , 1}^{( p )} , {y}_{n , 1} \\ {x}_{n , 2}^{( 1 )} , {x}_{n , 2}^{( 2 )} , … , {x}_{n , 2}^{( p )} , {y}_{n , 2} \\ ⋯ \\ {x}_{n , mn}^{( 1 )} , {x}_{1 , mn}^{( 2 )} , … , {x}_{1 , mn}^{( p )} , {y}_{1 , mn}\end{matrix} \} {Z}_{n}$$

In the manufacturing process data, x_{i,1}⁽¹⁾, . . . , x_{i,1}^{(p)} are known as a group of manufacturing process parameters, indicating a p number of manufacturing process parameters recorded during production of a first block of an i-th product, which is denoted by x_{i,1} hereinafter. Since the blocks included by each of the products may not necessarily be identical to the others, a number of the blocks included by the i-th product is denoted by mi. During the quality check of the products, a quality check result of the entire product may be recorded only.

In the present exemplary embodiment, the number of the products is n. Taking the i-th product for example, the quality check result of such product is denoted by Zᵢ and referred to as the product quality parameter. The group of the manufacturing process parameters recorded for any one block j of the product during production is denoted by x_{i,j}. Because the manufacturing process parameters are independent from each other, the manufacturing process parameters may also be referred to as an independent variable. Further, a quality corresponding to the block j is denoted by y_{i,j} and referred to as a block quality parameter. Generally, the block quality parameter is not recorded due to restrictions of the manufacturing environment, and this the block quality parameter belongs to a hidden variable.

It is possible that the quality check may not be performed right after the product is produced, and instead, the product is cut (divided) into multiple blocks before the quality check is performed on the divided blocks. However, during the process, it can only be known that the divided blocks are defective rather than exact locations of the defective blocks in the product, such that the manufacturing process parameters of the defective blocks cannot be identified. If any one of the blocks is defective in the blocks divided form the i-th product, it indicates that the product is defective before being divided, and thus the product i is recorded as defective (i.e., Zᵢ=defective). In other words, when the product quality parameter of the product i is non-defective, the block quality parameters of the blocks in the product i are all non-defective. Conversely, when the product quality parameter of the product i is defective, the block quality parameter of at least one of the blocks in the product i is defective. During various processes at different manufacturing process stages, one group of the manufacturing process parameters will be recorded for each block of the product, and thus multiple groups of the manufacturing process parameters will be recorded for one product. For example, a total of mi groups of the manufacturing process parameters is recorded for the product i. Accordingly, the product i may be regarded as including a mi number of the blocks, and each of the blocks has the corresponding manufacturing process parameters x_{i,1}, . . . , x_{i,m1}. In one embodiment, a block quality corresponding to each of the blocks (i.e., the block quality parameters y_{i,1}, . . . , y_{i,m1}) cannot be acquired. Instead, only whether the entire product i is defective (i.e., the product quality parameter Zᵢ=defective or Zᵢ=normal) may be known. In the following table, for example, a number of the products is 3 and each of the products includes 4 blocks (i.e., n=3, m1=4, m2=4 and m3=4).

TABLE 1

| | X1 | X2 | X3 | X4 | X5 | Y | Z |
|---|---|---|---|---|---|---|---|
| PID(1,1) | A | 107 | 44 | 69 | 890 | ? | Normal |
| PID(1,2) | A | 110 | 44 | 65 | 900 | ? | |
| PID(1,3) | A | 112 | 43 | 66 | 890 | ? | |
| PID(1,4) | A | 114 | 44 | 67 | 950 | ? | |
| PID(2,1) | B | 107 | 44 | 69 | 890 | ? | Defective |
| PID(2,2) | B | 110 | 44 | 68 | 900 | ? | |
| PID(2,3) | B | 150 | 45 | 65 | 880 | ? | |
| PID(2,4) | B | 114 | 44 | 67 | 950 | ? | |
| PID(3,1) | C | 107 | 44 | 69 | 890 | ? | Normal |
| PID(3,2) | C | 110 | 45 | 68 | 900 | ? | |
| PID(3,3) | C | 112 | 45 | 68 | 900 | ? | |
| PID(3,4) | C | 114 | 44 | 67 | 950 | ? | |

Referring to Table 1, PID represents a product ID; PID(1,1) represents a first block of a product 1; PID(1,2) represents a second block of the product 1; and the rest may be deduced by analogy. X1 to X5 are the manufacturing process parameters; Y is the block quality parameter; and Z is the product quality parameter. The manufacturing process parameter X1 is a non-numeric parameter, which has three types A, B, and C.

Referring back to FIG. 2, the evaluation module 220 is configured to use at least one of a non-probability based classifier and a probability based classifier to compute manufacturing process data in order to acquire a contribution rate of each of the manufacturing process parameters. In one exemplary embodiment of the present disclosure, if the evaluation module 220 uses the non-probability based classifier to compute the manufacturing process data, the evaluation module 220 will repeatedly update the block quality parameter and solve a classifier having a variable selection structure until all of the defective blocks checked by the classifier match a data feature, so as to acquire the contribution rate of each of the manufacturing process parameters. The aforesaid method is also known as an optimal labeling method. In another exemplary embodiment of the present disclosure, if the evaluation module 220 uses the probability based classifier to compute the manufacturing process data, the evaluation module 220 will establish a probability model classifier for each of the product quality parameter and the block quality parameter and add in the variable selection structure. Next, an Expectation-maximization algorithm is used to solve and acquire the contribution rate of each of the manufacturing process parameters. The aforesaid method is also known as a probability model method. The optimal labeling method and the probability model method will be described in more detail later.

It is worth mentioning that, in the present exemplary embodiment, the evaluation module 220 can, for example, select the at least one of the probability based classifier and the non-probability based classifier used to compute the manufacturing process data according to a classifier accuracy rate calculated by an input signal of a user and external data.

The determination module 230 is configured to determine whether the classifier accuracy rate is greater than a threshold. For example, in one exemplary embodiment, the threshold of the classifier accuracy rate may be set as 90%, but the present disclosure is not limited thereto. In another exemplary embodiment, the threshold of the classifier accuracy rate may also be set as other values based on different conditions. If the classifier accuracy rate is greater than the threshold, the comparison module 240 deletes the manufacturing process parameter having the lowest contribution rate among the manufacturing process parameters, and uses the classifier to compute the manufacturing process data again in order to acquire the contribution rate of each of the manufacturing process parameters. Aforesaid step will repeat until the classifier accuracy rate is not greater than the threshold. Then, the comparison module 240 sets the manufacturing process parameters not yet deleted plus the last manufacturing process parameter deleted as one or more crucial manufacturing process parameters. Lastly, the comparison module 240 performs an efficacy comparison on a classifier established by using the one or more crucial manufacturing process parameters (also known as a reduced model) and a classifier established by using all of the original manufacturing process parameters (also known as a full model), and checks whether the reduced model has a similar classification result (e.g., a classification accuracy rate, a false acceptance rate (i.e., mistakenly determining the defective product as normal) or a false rejection rate (i.e., mistakenly determining the normal product as defective)) with respect to the full classifier, so as to determine if the manufacturing process parameters in the reduced model is the important cause causing the defect.

Further, after acquiring the manufacturing process data, the coding module 250 performs a numeric coding on a non-numeric variable in the manufacturing process parameters. In the present exemplary embodiment, the coding module 250 can perform the numeric coding on the non-numeric variable by using a dummy variable method or an optimal scale method. The optimal scale method is a coding method in a numeric manner. First of all, one coding value is randomly assigned for the non-numeric variable during initialization. For example, in Table 1 above, the manufacturing process parameter X1 has three values A, B and C. During initialization, A is coded as a value 1; B is coded as a value 2; and C is coded as a value 3. Next, the optimal scale method is used on the acquired manufacturing process data to calculate, for example, an optimal coding value of A being −0.074, an optimal coding value of B being −0.1964, and an optimal coding value of C being 0.2344. In the dummy variable method, if the non-numeric variable originally has a n number of values (or known a n number of levels), the coding module 250 can perform the coding by using a (n−1) number of variables. For example, in Table 1 above, the manufacturing process parameter has three values A, B and C. A first new parameter may be used to indicate whether the original parameter is A. If the original parameter is A, the first new parameter is 1, or otherwise, 0. Next, a second new parameter may be used to indicate whether the original parameter is B. If the original parameter is B, the second new parameter is 1, or otherwise, 0. When the original parameter is C, the first new parameter and the second new parameter are both 0. Further, after the numeric coding is performed on the non-numeric variable in the manufacturing process parameters by the coding module 250, the manufacturing process data may be represented by Table 2 below.

TABLE 2

| | X1 | X2 | X3 | X4 | X5 | X6 | Y | Z |
|---|---|---|---|---|---|---|---|---|
| PID(1,1) | 1 | 0 | 107 | 44 | 69 | 890 | ? | Normal |
| PID(1,2) | 1 | 0 | 110 | 44 | 65 | 900 | ? | |
| PID(1,3) | 1 | 0 | 112 | 43 | 66 | 890 | ? | |
| PID(1,4) | 1 | 0 | 114 | 44 | 67 | 950 | ? | |
| PID(2,1) | 0 | 1 | 107 | 44 | 69 | 890 | ? | Defective |
| PID(2,2) | 0 | 1 | 110 | 44 | 68 | 900 | ? | |
| PID(2,3) | 0 | 1 | 150 | 45 | 65 | 880 | ? | |
| PID(2,4) | 0 | 1 | 114 | 44 | 67 | 950 | ? | |
| PID(3,1) | 0 | 0 | 107 | 44 | 69 | 890 | ? | Normal |
| PID(3,2) | 0 | 0 | 110 | 45 | 68 | 900 | ? | |
| PID(3,3) | 0 | 0 | 112 | 45 | 68 | 900 | ? | |
| PID(3,4) | 0 | 0 | 114 | 44 | 67 | 950 | ? | |

In Table 2, original non-numeric data in the manufacturing process parameter X1 in Table 1 are replaced by the numeric data of the first new parameter X1 and the second new parameter X2. Accordingly, the classifier may then be used to compute the manufacturing process data.

It should be noted that, when the user of the manufacturing process variation cause analysis system 200 intends to start the analysis on the cause of the defect in the manufacturing process, the data to be analyzed may be selected by using a user interface (not illustrated). In one exemplary embodiment, the user interface may be a computer program, which is operated on a personal computer, an industrial computer or work station, and capable of allowing the user to input analysis commands, acquiring and presenting an analysis result. In another exemplary embodiment, the user interface may also be a web service, which is operated on a personal computer, an industrial computer or work station, where the user are able to input analysis commands through a terminal with input-output interface such as a personal computer, a tablet computer, a smart phone and the like, so that an analysis result may be acquired and presented.

The storage module 260 may be, for example, a non-volatile memory such as a hard disk (HDD), a solid state drive or the like. In one exemplary embodiment, the storage module 260 may at least include a manufacturing process parameter database, a quality measure database, a manufacturing process parameter contribution rate database and a classification efficacy database. The manufacturing process parameter database is configured to record the sensed values of the sensors and the control values set for the manufacturing process parameters. The quality measure database is configured to record the quality check result of the product. The manufacturing process parameter contribution rate database is configured to record the contribution rate of the manufacturing process parameter acquired by the classifier. The classification efficacy database is configured to record classification efficacies of the reduced model and the full model. Although it is described above that related data of the manufacturing process parameters, product quality and efficacy check results are stored in different databases, the present disclosure is not limited thereto. In another exemplary embodiment, all the related data of the manufacturing process parameters, product quality and efficacy check results may also be stored in a server database of the storage module 260.

In one exemplary embodiment, the collecting module 210 is, for example, a sensor capable of measuring various values (e.g., a temperature, a pressure, a flow rate of gas or liquid, etc.), and configured to transmit a sensing result back to the storage module 260. In one exemplary embodiment, a circuit design for the evaluation module 220, the determination module 230, the comparison module 240 and the coding module 250 may be performed by using a hardware description language (e.g., Verilog or VHDL) followed by conducting integration and arrangement thereto and then burnt onto a field programmable logic array (FPLA). The circuit design completed by using the hardware description language may be implemented as an application-specific integrated circuit (ASIC) or a so-called dedicated integrated circuit by, for example, professional IC producers, but the present disclosure is not limited thereto. In another exemplary embodiment, the evaluation module 220, the determination module 230, the comparison module 240 and the coding module 250 may also be implemented as software or firmware, which may be executed by a processor in order to realize their own functions.

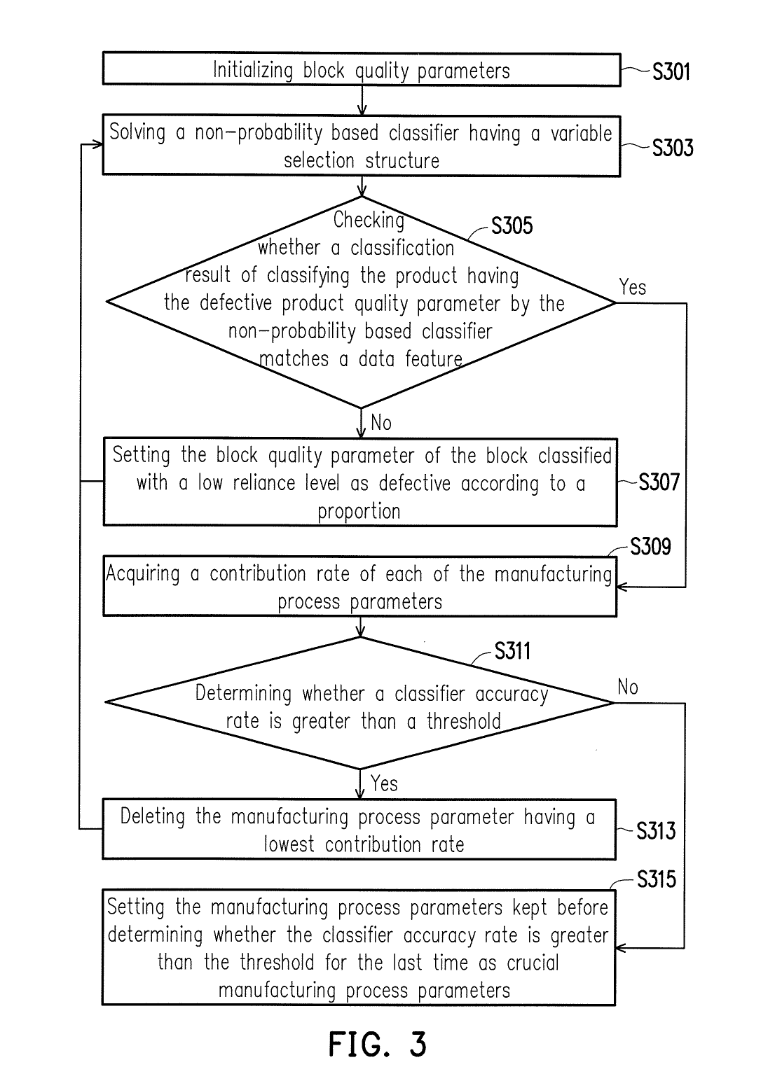

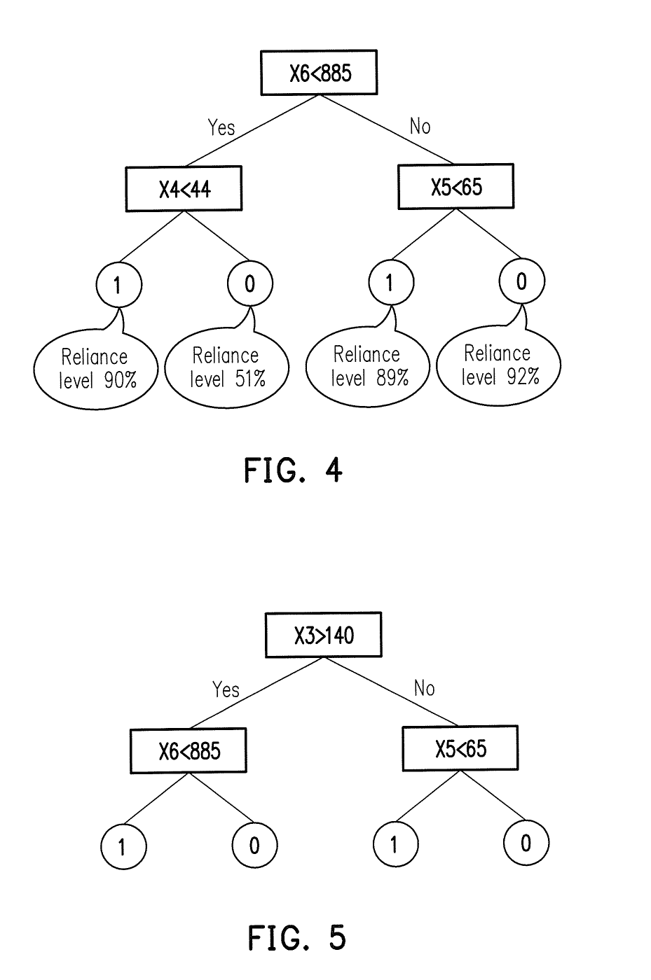

FIG. 3 is a flowchart illustrating an optimal labeling method according to an exemplary embodiment of the present disclosure, FIG. 4 illustrates a classifier having a variable selection structure according to an exemplary embodiment of the present disclosure, and FIG. 5 illustrates a classifier having a variable selection structure according to an exemplary embodiment of the present disclosure.

Referring to FIG. 3, in step S301, block quality parameters are initialized, and detailed description regarding the same may refer to Table 3 below.

TABLE 3

| | X1 | X2 | X3 | X4 | X5 | X6 | Y | Z |
|---|---|---|---|---|---|---|---|---|
| PID(1,1) | 1 | 0 | 107 | 44 | 69 | 890 | −1 | −1 |
| PID(1,2) | 1 | 0 | 110 | 44 | 65 | 900 | −1 | |
| PID(1,3) | 1 | 0 | 112 | 43 | 66 | 890 | −1 | |
| PID(1,4) | 1 | 0 | 114 | 44 | 67 | 950 | −1 | |
| PID(2,1) | 0 | 1 | 107 | 44 | 69 | 890 | 1 | 1 |
| PID(2,2) | 0 | 1 | 110 | 44 | 68 | 900 | 1 | |
| PID(2,3) | 0 | 1 | 150 | 45 | 65 | 880 | 1 | |
| PID(2,4) | 0 | 1 | 114 | 44 | 67 | 950 | 1 | |
| PID(3,1) | 0 | 0 | 107 | 44 | 69 | 890 | −1 | −1 |
| PID(3,2) | 0 | 0 | 110 | 45 | 68 | 900 | −1 | |
| PID(3,3) | 0 | 0 | 112 | 45 | 68 | 900 | −1 | |
| PID(3,4) | 0 | 0 | 114 | 44 | 67 | 950 | −1 | |

Referring to Table 3, in the present exemplary embodiment, a value related to the product quality parameter Z is set as −1 when product quality is normal and is set as 1 when product quality is defective. However, the disclosure is not limited thereto. In another exemplary embodiment, the value of the product quality parameter Z may also be set according to a defect severity level (e.g., the value is 1 in case of minor defect and is 2 in case of severe defect). In the present exemplary embodiment, for illustrative convenience, the value of the product quality parameter Z is simply either 1 or −1. After the value of the product quality parameter Z is given, values of the block quality parameters Y will be initially set as the same value of the product quality parameter Z.

Referring back FIG. 3, in step S303, a non-probability based classifier having a variable selection structure is solved. Next, in step S305, whether a classification result of classifying the product having the defective product quality parameter by the non-probability based classifier matches a data feature is checked. Herein, referring to FIG. 4 together, specifically, for all the products having Z=1, the manufacturing process parameters X are inputted one by one to a classifier of FIG. 4, and whether the classification results matches the data feature is checked. If the defect denoted by Z has levels, a number of defective blocks may also be set. For example, at least 50% of the blocks in the product has Y=1 when Z is severe defective, whereas at least 10% of the blocks in the product has Y=1 when Z is minor defective. In the present exemplary embodiment, for illustrative convenience, it is set that when one product has Z=1, at least one block of said product has Y=1. Herein, when four blocks of PID2 are all inputted to the classifier of FIG. 4, the generated Y values are all −1, as shown in Table 4 below.

TABLE 4

| | X1 | X2 | X3 | X4 | X5 | X6 | Y | Z |
|---|---|---|---|---|---|---|---|---|
| PID(2,1) | 0 | 1 | 107 | 44 | 69 | 890 | −1 | 1 |
| PID(2,2) | 0 | 1 | 110 | 44 | 68 | 900 | −1 | |
| PID(2,3) | 0 | 1 | 150 | 45 | 65 | 880 | −1 | |
| PID(2,4) | 0 | 1 | 114 | 44 | 67 | 950 | −1 | |

Because Z=1 indicates that at least one block has Y=1, it can be known that this classification result does not match the data feature (which means that such classifier has a biased error). Accordingly, in step S307, the block quality parameter of the block classified with a low reliance level is set as defective according to a proportion. In the present exemplary embodiment, it is assumed that the defect severity level is minor defective, and the corresponding data feature is: if one product has Z=1, at least one block in the product has Y=1. Accordingly, in the present exemplary embodiment, the block quality parameter of the block classified with a lowest reliance level is set as defective (e.g., Y of PID(2,3) is set as 1). In another exemplary embodiment, if the defect severity level is severe defective, the corresponding data feature is: if one product has Z=1, at least a half of the blocks in the product has Y=1. In this case, the blocks in the defective product are sorted according to the reliance level, and Y of the blocks with low reliance level are sequentially set as 1 until the half of the blocks is set as defective, so as to satisfy the data feature. Next, returning back to step S303, the non-probability based classifier having the variable selection structure is re-solved, as shown in FIG. 5.

When it is checked by the non-probability based classifier that the defective product quality parameter of all the defective blocks match the data feature, in step S309, a contribution rate of each of the manufacturing process parameters is acquired, as shown in Table 5 below.

TABLE 5

| | X1 | X2 | X3 | X4 | X5 | X6 |
|---|---|---|---|---|---|---|
| Contribution | 5 | 6 | 36 | 0 | 24 | 29 |
| rate | | | | | | |

Next, in step S311, whether a classifier accuracy rate is greater than a threshold is determined. If the classifier accuracy rate is greater than the threshold, in step S313, the manufacturing process parameter having a lowest contribution rate is deleted. For example, the manufacturing process parameter X4 having the contribution rate being 0 in Table 5 is deleted. Then, returning back to step S303, in which the classifier is re-solved. The above process will repeat until the classifier accuracy rate is not greater than the threshold. In step S315, the manufacturing process parameters kept before determining whether the classifier accuracy rate is greater than the threshold for the last time are set as crucial manufacturing process parameters. As shown in Table 6, the manufacturing process parameters X3, X5 and X6 will be set as the crucial manufacturing process parameters.

TABLE 6

| | X3 | X5 | X6 |
|---|---|---|---|
| Contribution rate | 36 | 24 | 29 |

It is worth mentioning that, for example, in one exemplary embodiment, a part of the manufacturing process data (e.g., 70% of the manufacturing process data) may be used as training data of the classifier, and the rest of the manufacturing process data (e.g., 30% of the manufacturing process data) may be used as test data for testing the classifier accuracy rate.

In one exemplary embodiment, a SVM classifier may be used as the non-probability based classifier having the variable selection structure being solved in step S303, and an objective function of the SVM classifier is provided as follows:

$${min}_{{β}_{0} , β} \frac{1}{{\sum }_{i = 2}^{n} m i} {\sum }_{i = 1}^{n} {( {\sum }_{j = 1}^{m i} 1 - {y}_{i , j} ( {β}_{0} + {x}_{i , j}^{T} β ) )}_{+} + \frac{λ}{2} {‖ β ‖}_{2}^{2}$$

wherein n is the number of products. mi is the number of blocks of an i-th product. y_{i,j} is a block quality parameter of a j-th block of the i-th product, which is either −1 or 1. x_{i,j} is a manufacturing process parameter of the j-th block of the i-th product. β₀ is a constant. p is the number of the manufacturing process parameters, and β is a p×1 coefficient vector. λ is a regularization parameter greater than or equal to 0.

After variable selection structure is added in, the objective function becomes:

$${min}_{{β}_{0} , β} \frac{1}{{\sum }_{i = 2}^{n} m i} {\sum }_{i = 1}^{n} {( {\sum }_{j = 1}^{m i} 1 - {y}_{i , j} ( {β}_{0} + {x}_{i , j}^{T} β ) )}_{+} + {λ}_{1} {‖ β ‖}_{1} + \frac{{λ}_{2}}{2} {‖ β ‖}_{2}^{2} \qquad ( 1 )$$

wherein λ₁ and λ₂ are the regularization parameters greater than or equal to 0.

Solutions β₀ and β of the SVM classifier may be acquired by solving the equation (1). The solved SVM classifier may be used to estimate the corresponding Y by using the inputted manufacturing process parameter X corresponding to the block. In addition, because the solved classifier has the variable selection structure, the contribution rate (or a significance extent) of each of the manufacturing process parameters may further be estimated. For instance, the SVM classifier used in the present exemplary embodiment may quantize the contribution rate of each of the manufacturing process parameters by using an OOB (Out-Of-Bag) method. Specifically, assuming that there is a p number of the manufacturing process parameters {v₁, v₂ . . . , vₚ}, one SVM classifier may be established by using those manufacturing process parameters, and a loss value lossₐ of the SVM classifier may be calculated by using a SVM loss function. Next, one manufacturing process parameter vᵢ is deleted one at a time followed by re-establishing the SVM classifier by using the remaining p−1 number of the manufacturing process parameters, and then the loss value lossᵢ of the classifier is calculated by using the SVM loss function, where i=1 to p. Lastly, Dᵢ=|lossₐ−lossᵢ| is calculated. When Dᵢ is greater, it indicates that the loss is greater after deleting the manufacturing process parameter vᵢ (i.e., the contribution rate of vᵢ is higher). Therefore, the contribution rates of the p number of the manufacturing process parameters may be represented by Dᵢ, where i=1 to p.

A complete algorithm taking the SVM classifier for example is provided according to one exemplary embodiment as follows:

```
the product with index i, associate with a label Zᵢ ∈ {−1,1}
if Zᵢ = −1, then y_{i,j} = −1 for all j ∈ mi
if Zᵢ = 1, then at least one y_{i,j} = 1 for j ∈ mi
initialize y_{i,j} = Zᵢ for j ∈ mi, i ∈ n; β = NULL , β₀ = NULL
REPEAT
  IF(β ≠ NULL and β₀ ≠ NULL)
    compute the contribution C of covariates based on β and β₀
    delete the covariate corresponding to the minimum C from the
    data set
  END
  REPEAT
    compute SVM solution β,β₀ for data set with imputed labels
    compute outputs f_{i,j} = β₀ + x_{i,j}^{T} β for all x_{i,j} in positive product
    set y_{i,j} = sgn(f_{i,j}) for every j ∈ mi,Zᵢ = 1
    FOR(every positive product i)
      IF(Σ_{j∈mi}(1 + y_{i,j})/2 == 0)
        coumpte j* = arg max_{j∈mi} f_{i,j}
        set y_{i,j} = 1
      END
    END
  WHILE (imputed labels have changed)
WHILE (accuracy rate of the SVM solution for the data set is acceptable)
OUTPUT C
```

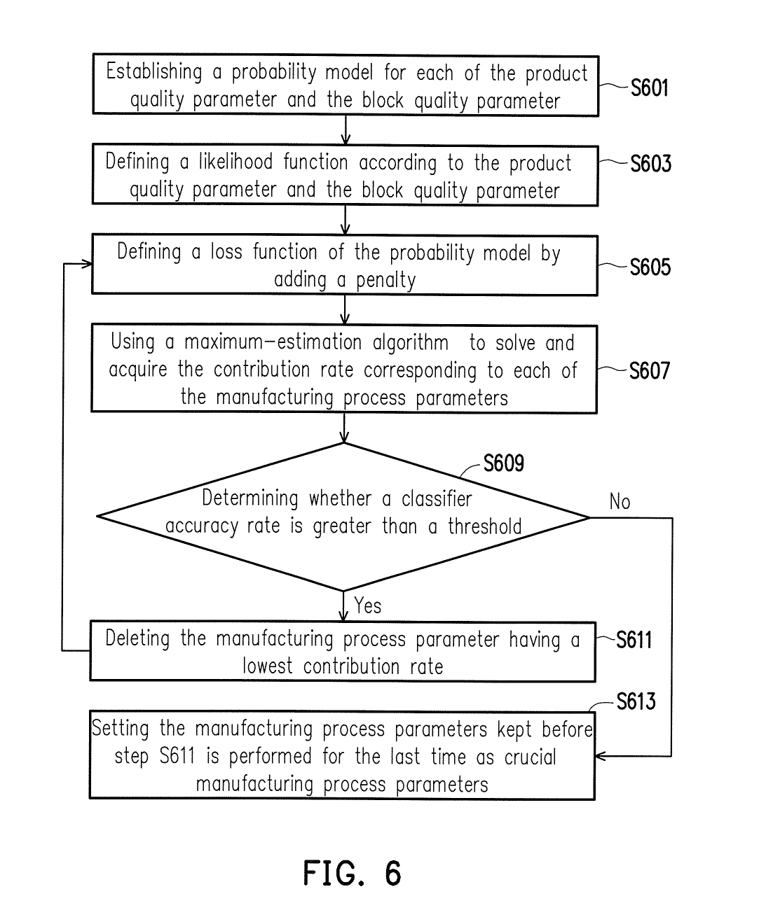

FIG. 6 is a flowchart illustrating a probability model method according to one exemplary embodiment of the present disclosure.

Referring to FIG. 6, in step S601, a probability model is established for each of the product quality parameter and the block quality parameter, so as to describe a probability that the quality of the block in the product is defective and a probability that the quality check result of the product is defective. In the present exemplary embodiment, the probability models may be established by using a logistic regression (LR). The probability model of the block quality parameter is provided as follows:

$${Pr}_{i , j} = \frac{1}{1 + {e}^{- ( {β}_{0} + {x}_{i , j}^{T} β )}}$$

wherein Pr_{i,j} is a probability that a j-th block of an i-th product is defective. x_{i,j} is a manufacturing process parameter of the j-th block of the i-th product. p is the number of the manufacturing process parameters. β is a p×1 coefficient vector. β₀ is a constant.

The probability model of the product quality parameter is provided as follows:

πᵢ=1−Πⱼ₌₁^{mi}(1−Pr_{i,j})

wherein πᵢ is a probability that the i-th product is defective, mi is a number of the blocks of the i-th product. Because 1−Pr_{i,j} is a probability that the j-th block of the i-th product is non-defective, a probability that the i-th product is non-defective may by acquired by multiplying all the probabilities of all the blocks of the i-th product being non-defective, so that πᵢ will be the probability that the i-th product is defective.

In step S603, a likelihood function is defined according to the product quality parameter and the block quality parameter. The likelihood function is provided as follows:

$$L ( {β}_{0} , β ) = {\prod }_{i = 1}^{n} {{π}_{i}^{{Z}_{i}} ( 1 - {π}_{i} )}^{1 - {Z}_{i}}$$

$$1 - {Z}_{i} = {\prod }_{j = 1}^{m i} I ( {y}_{i , j} = 0 )$$

wherein n is the number of products. mi is the number of the blocks of an i-th product. Zi is a binary product quality parameter of the i-th product, which is either 0 or 1. y_{i,j} is a binary block quality parameter of a j-th block of the i-th product, which is either 0 or 1. In the product i which is non-defective, because y_{i,j} of all the blocks are 0, it can be known that Zi=0 since 1−Zi=1. In the product i which is defective, because y_{i,j} of at least one block is 1, it can be known that Zi=1 since 1−Zi=0.

In step S605, a loss function of the probability model is defined by adding a penalty. The loss function of the logistic regression is provided as follows:

$${min}_{{β}_{0} , β} \{ - log ( L ( {β}_{0} , β ) ) + λ {\sum }_{k = 1}^{p} \vert {β}_{k} \vert \} \qquad ( 2 )$$

wherein λ is a regularization parameter greater than or equal to 0, and p is the number of the manufacturing process parameters.

After the loss function is defined, values of the product quality parameters will be given. In the present exemplary embodiment, a value of Z is 0 when the product quality is normal and the value of Z is 1 when the product quality is defective. A result of the above is as shown by Table 7 below.

TABLE 7

| | X1 | X2 | X3 | X4 | X5 | X6 | Y | Z |
|---|---|---|---|---|---|---|---|---|
| PID(1,1) | 1 | 0 | 107 | 44 | 69 | 890 | ? (Pr_{1,1}) | 0 |
| PID(1,2) | 1 | 0 | 110 | 44 | 65 | 900 | ? (Pr_{1,2}) | |
| PID(1,3) | 1 | 0 | 112 | 43 | 66 | 890 | ? (Pr_{1,3}) | |
| PID(1,4) | 1 | 0 | 114 | 44 | 67 | 950 | ? (Pr_{1,4}) | |
| PID(2,1) | 0 | 1 | 107 | 44 | 69 | 890 | ? (Pr_{2,1}) | 1 |
| PID(2,2) | 0 | 1 | 110 | 44 | 68 | 900 | ? (Pr_{2,2}) | |
| PID(2,3) | 0 | 1 | 150 | 45 | 65 | 880 | ? (Pr_{2,3}) | |
| PID(2,4) | 0 | 1 | 114 | 44 | 67 | 950 | ? (Pr_{2,4}) | |
| PID(3,1) | 0 | 0 | 107 | 44 | 69 | 890 | ? (Pr_{3,1}) | 0 |
| PID(3,2) | 0 | 0 | 110 | 45 | 68 | 900 | ? (Pr_{3,2}) | |
| PID(3,3) | 0 | 0 | 112 | 45 | 68 | 900 | ? (Pr_{3,3}) | |
| PID(3,4) | 0 | 0 | 114 | 44 | 67 | 950 | ? (Pr_{3,4}) | |

In step S607, an Expectation-maximization (EM) algorithm is used to solve and acquire the contribution rate corresponding to each of the manufacturing process parameters. Specifically, first of all, the manufacturing process data in Table 2 are substituted in the equation (2) and then the equation (2) is solved by using the Expectation-maximization algorithm in order to acquire solutions β₀ and β of a logistic regression classifier. The solved logistic regression classifier may be used to estimate a probability that the corresponding Y=1 by using the inputted manufacturing process parameter X corresponding to the block. Further, an absolute value of the coefficient β can represent the significance extent of each of the manufacturing process parameters X. Herein, it is assumed that the solved coefficient β is as shown by Table 8 below.

TABLE 8

| | X1 | X2 | X3 | X4 | X5 | X6 |
|---|---|---|---|---|---|---|
| β | 0.25 | 0.3 | −3.2 | 0 | 2.6 | 2.8 |

In step S609, whether a classifier accuracy rate is greater than a threshold is determined. If the classifier accuracy rate is greater than the threshold, in step S611, the manufacturing process parameter having a lowest contribution rate is deleted (e.g., the manufacturing process parameter X4 having the β value being 0 in Table 8 is deleted). Then, returning back to step S605. The above process will repeat until the classifier accuracy rate is not greater than the threshold. In step S613, the manufacturing process parameters kept before step S611 is performed for the last time are set as crucial manufacturing process parameters. As shown in Table 9, the manufacturing process parameters X3, X5 and X6 will be set as the crucial manufacturing process parameters.

TABLE 9

| | X3 | X5 | X6 |
|---|---|---|---|
| Contribution rate | 3.1 | 2.5 | 2.7 |

A complete algorithm of the probability model taking the logistic regression for example is provided according to one exemplary embodiment as follows:

```
initialize β = NULL, β₀ = NULL
REPEAT
  IF(β ≠ NULL and β₀ ≠ NULL)
    compute the contribution C of covariates based on β and β₀
    delete the covariate corresponding to the minimum C from the data set, update p
  END
  $Objective function of Logistic Regression = {min}_{{β}_{0} , β} \{ - log ( L ( {β}_{0} , β ) ) + λ {\sum }_{k = 1}^{p} \vert {β}_{k} \vert \}$
  using EM Algorithm to solve the objective function of Logistic Regression, get β₀, β
WHILE (accuracy rate of the Logistic Regression solution for the data set is acceptable)
OUTPUT C
```

Although the method for analyzing variation causes of manufacturing process of the present disclosure is described above based on one product including multiple blocks (i.e., the manufacturing process parameters are corresponding to the blocks of the product and the product quality parameter is corresponding to each of the products) in the foregoing exemplary embodiments, the present disclosure is not limited thereto.

### Second Exemplary Embodiment

In the present exemplary embodiment, products may be divided into a plurality of groups. Each of the products in the group has corresponding manufacturing process parameters, and each of the groups has a corresponding product quality parameter. For instance, 100 products may be divided into 10 groups, and only one product is randomly selected from each of the groups for quality check, and a quality check result thereof is used to represent a product quality parameter of the corresponding group. In the present exemplary embodiment, only the product quality parameter of one group can be acquired instead of a product quality parameter of each of the products. Therefore, the product quality parameter of each of the products and the product quality parameter of each of the groups in the present exemplary embodiment may refer to the block quality parameter and the product quality parameter as described in the first exemplary embodiment respectively, so that the method for analyzing variation causes of manufacturing process of the present disclosure may be used thereto.

### Third Exemplary Embodiment

In the present exemplary embodiment, a manufacturing process of one product may be divided into a plurality of manufacturing time sections. The manufacturing time sections of each product have corresponding manufacturing process parameters and each of the products has a corresponding product quality parameter. For instance, in the case where the manufacturing process parameters are sampled once per ten seconds while manufacturing one product, assuming that it takes two minutes to manufacture the product, the product will have 12 groups of the manufacturing process parameters corresponding to different manufacturing time sections. In the present exemplary embodiment, only a product quality parameter sampled when the product is completed can be acquired instead of a product quality parameter of the product in each manufacturing time section. Therefore, the product quality parameter of each manufacturing time section and the product quality parameter sampled when the product is completed in the present exemplary embodiment may refer to the block quality parameter and the product quality parameter as described in the first exemplary embodiment respectively, so that the method for analyzing variation causes of manufacturing process of the present disclosure may be used thereto.

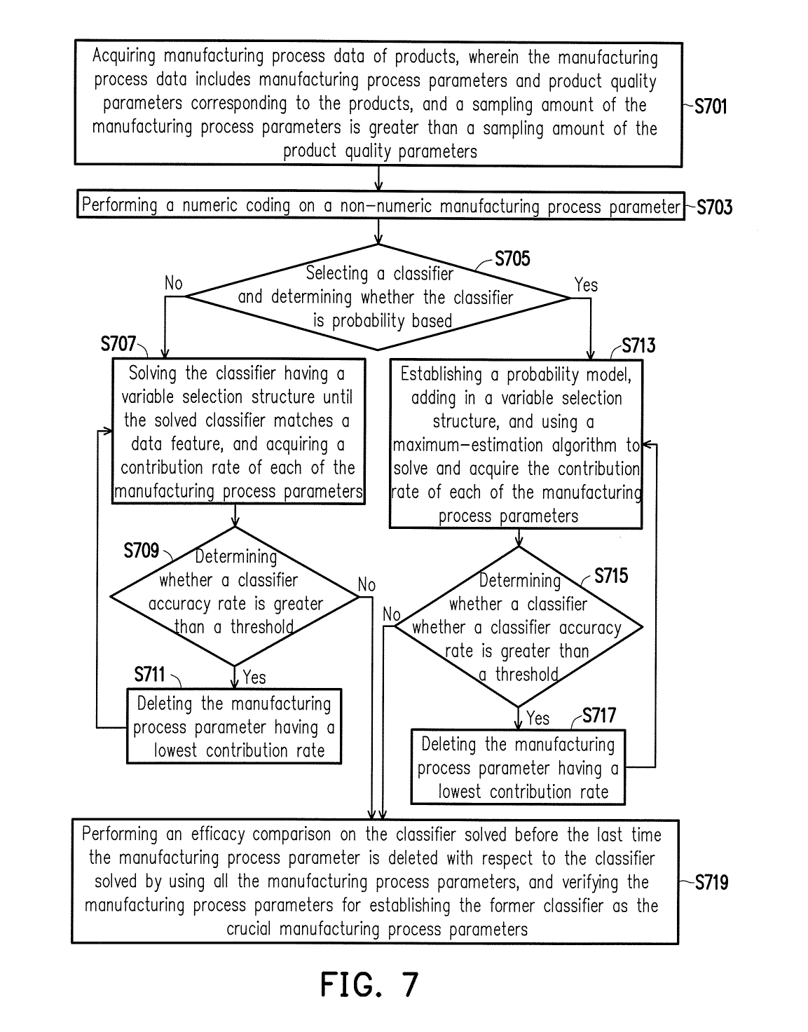

FIG. 7 is a flowchart illustrating a method for analyzing variation causes of manufacturing process according to an exemplary embodiment of the present disclosure.

Referring to FIG. 7, in step S701, manufacturing process data of products is acquired, wherein the manufacturing process data includes manufacturing process parameters and product quality parameters corresponding to the products, and a sampling amount of the manufacturing process parameters is greater than a sampling amount of the product quality parameters.

In step S703, a numeric coding is performed on a non-numeric manufacturing process parameter.

In step S705, a classifier is selected and whether the classifier is probability based is determined. Herein, the probability based classifier and non-probability based classifier may be selected according to the classifier accuracy rate calculated by an input signal and external data.

If the classifier is not probability based, in step S707, the classifier having a variable selection structure is solved until the solved classifier matches a data feature, and a contribution rate of each of the manufacturing process parameters is acquired.

Next, in step S709, whether a classifier accuracy rate is greater than a threshold is determined. If the classifier accuracy rate is greater than the threshold, in step S711, the manufacturing process parameter having a lowest contribution rate is deleted, and the classifier is re-solved in step S707. If the classifier accuracy rate is not greater than the threshold, in step S719, an efficacy comparison is performed on the classifier solved before the last time the manufacturing process parameter is deleted with respect to the classifier solved by using all the manufacturing process parameters, and at least one of the manufacturing process parameters for establishing the former classifier is verified as at least one crucial manufacturing process parameter.

If the classifier is probability based, in step S713, a probability model is established, a variable selection structure is added in, and an Expectation-maximization algorithm is used to solve and acquire the contribution rate of each of the manufacturing process parameters.

Next, in step S715, whether a classifier accuracy rate is greater than a threshold is determined. If the classifier accuracy rate is greater than the threshold, in step S717, the manufacturing process parameter having a lowest contribution rate is deleted, and the classifier is re-solved in step S713. If the classifier accuracy rate is not greater than the threshold, in step S719, an efficacy comparison is performed on the classifier solved before the last time the manufacturing process parameter is deleted with respect to the classifier solved by using all the manufacturing process parameters, and at least one of the manufacturing process parameters for establishing the former classifier is verified as the crucial manufacturing process parameter.

In summary, according to the present disclosure, the manufacturing process data is acquired, the numeric coding is performed on the non-numeric variable in the manufacturing process parameters, and the classifier is solved by the optimal labeling method or the probability model method to acquire the contribution rate of each of the manufacturing process parameters. If the classifier accuracy rate is not greater than the threshold, the manufacturing process parameter having the low contribution rate is deleted, so as to acquire the crucial manufacturing process parameters. Lastly, the efficacy of the classifier solved by using the crucial manufacturing process parameters and the classifier solved by using all the manufacturing process parameters are compared, which is then used to verify whether the crucial manufacturing process parameters are the important cause causing the defect.

Although the present disclosure has been described with reference to the above embodiments, it is apparent to one of the ordinary skill in the art that modifications to the described embodiments may be made without departing from the spirit of the present disclosure. Accordingly, the scope of the present disclosure will be defined by the attached claims not by the above detailed descriptions.

What is claimed is:

1. A method for analyzing variation causes of manufacturing process, comprising:
acquiring manufacturing process data of a plurality of products, wherein the manufacturing process data comprises a plurality of manufacturing process parameters and a product quality parameter corresponding to the products;
using at least one of a non-probability based classifier and a probability based classifier to compute the manufacturing process data to acquire a contribution rate of each of the manufacturing process parameters;
determining whether a classifier accuracy rate is greater than a threshold;
if the classifier accuracy rate is greater than the threshold, performing a deleting operation on the manufacturing process parameters to delete the manufacturing process parameter having a lowest contribution rate, and using the at least one of the non-probability based classifier and the probability based classifier to compute the manufacturing process data to acquire the contribution rate of each of the manufacturing process parameters; and
if the classifier accuracy rate is not greater than the threshold, setting at least one of the manufacturing process parameters as at least one crucial manufacturing process parameter.

2. The method for analyzing variation causes of manufacturing process according to claim 1, further comprising: performing an efficacy comparison on a first classifier established by using the at least one crucial manufacturing process parameter and a second classifier established by using the manufacturing process parameters which the deleting operation is not performed, and checking whether the first classifier and the second classifier have a similar classification efficacy.

3. The method for analyzing variation causes of manufacturing process according to claim 1, wherein if the classifier accuracy rate is not greater than the threshold, the step of setting at least one of the manufacturing process parameters as the at least one crucial manufacturing process parameter comprises:
setting the manufacturing process parameters not deleted by the deleting operation plus the manufacturing process parameter deleted in the last deleting operation as the at least one crucial manufacturing process parameter.

4. The method for analyzing variation causes of manufacturing process according to claim 1, further comprising: selecting the at least one of the probability based classifier and the non-probability based classifier used to compute the manufacturing process data according to the classifier accuracy rate calculated by an input signal and external data.

5. The method for analyzing variation causes of manufacturing process according to claim 1, further comprising: after acquiring the manufacturing process data, performing a numeric coding on a non-numeric variable in the manufacturing process parameters.

6. The method for analyzing variation causes of manufacturing process according to claim 5, wherein the step of performing the numeric coding on the non-numeric variable in the manufacturing process parameters comprises: performing the numeric coding on the non-numeric variable by using a dummy variable method or an optimal scale method.

7. The method for analyzing variation causes of manufacturing process according to claim 1, wherein each of the products comprises a plurality of blocks, and the step of acquiring the manufacturing process data of the products comprises: acquiring the manufacturing process parameters corresponding to each of the blocks and acquiring the product quality parameter corresponding to each of the products.

8. The method for analyzing variation causes of manufacturing process according to claim 7, wherein the step of acquiring the manufacturing process data of the products further comprises:
initializing a block quality parameter corresponding to the blocks of the products according to the product quality parameters of the products.

9. The method for analyzing variation causes of manufacturing process according to claim 8, wherein when the product quality parameter of one of the products is non-defective, the block quality parameters of the blocks in said one of the products are all non-defective.

10. The method for analyzing variation causes of manufacturing process according to claim 8, wherein when the product quality parameter of at least one of the products is defective, the block quality parameter of at least one of the blocks in said at least one of the products is defective.

11. The method for analyzing variation causes of manufacturing process according to claim 8, wherein the step of using the non-probability based classifier to compute the manufacturing process data comprises:
solving the non-probability based classifier having a variable selection structure;
checking whether a classification result of classifying the product having the defective product quality parameter by the non-probability based classifier matches a data feature; and
if the classification result of the non-probability based classifier does not match the data feature, setting the block quality parameter of at least one of the blocks in the product classified with a low reliance level as defective according to a proportion, and re-solving the non-probability based classifier having the variable selection structure.

12. The method for analyzing variation causes of manufacturing process according to claim 11, wherein if the classification result of the non-probability based classifier matches the data feature, acquiring the contribution rate of each of the manufacturing process parameters.

13. The method for analyzing variation causes of manufacturing process according to claim 8, wherein the step of using the probability based classifier to compute the manufacturing process data comprises:
establishing a probability model for each of the product quality parameter and the block quality parameter;
defining a likelihood function according to the product quality parameter and the block quality parameter;
defining a loss function of the probability model by adding a penalty; and
using an Expectation-maximization algorithm to solve and acquire the contribution rate corresponding to each of the manufacturing process parameters.

14. The method for analyzing variation causes of manufacturing process according to claim 13, wherein the probability model is established based on a logistic regression.

15. The method for analyzing variation causes of manufacturing process according to claim 1, wherein the products are divided into a plurality of groups, and the step of acquiring the manufacturing process data of the products comprises: acquiring the process parameters corresponding to each of the products in the groups and acquiring the product quality parameter corresponding to each of the groups.

16. The method for analyzing variation causes of manufacturing process according to claim 1, wherein the step of acquiring the manufacturing process data of the products comprises: acquiring the manufacturing process parameters corresponding to a plurality of manufacturing time sections of each of the products and acquiring the product quality parameter corresponding to each of the products.

17. A system for analyzing variation causes of manufacturing process, comprising:
a collecting module, configured to acquire manufacturing process data of a plurality of products, wherein the manufacturing process data comprises a plurality of manufacturing process parameters and a product quality parameter corresponding to the products;
an evaluation module, configured to use at least one of a non-probability based classifier and a probability based classifier to compute the manufacturing process data to acquire a contribution rate of each of the manufacturing process parameters;
a determination module, configured to determine whether a classifier accuracy rate is greater than a threshold; and
a comparison module, wherein if the classifier accuracy rate is greater than the threshold, the comparison module performs a deleting operation on the manufacturing process parameters to delete the manufacturing process parameter having a lowest contribution rate, and uses the at least one of the non-probability based classifier and the probability based classifier to compute the manufacturing process data to acquire the contribution rate of each of the manufacturing process parameters, wherein if the classifier accuracy rate is not greater than the threshold, the comparison module sets at least one of the manufacturing process parameters as at least one crucial manufacturing process parameter.

18. The system for analyzing variation causes of manufacturing process according to claim 17, wherein the comparison module performs an efficacy comparison on a first classifier established by using the at least one crucial manufacturing process parameter and a second classifier established by using the manufacturing process parameters which the deleting operation is not performed, and checks whether the first classifier and the second classifier have a similar classification efficacy.

19. The system for analyzing variation causes of manufacturing process according to claim 17, wherein the comparison module sets the manufacturing process parameters not deleted by the deleting operation plus the manufacturing process parameter deleted in the last deleting operation as the at least one crucial manufacturing process parameter.

20. The system for analyzing variation causes of manufacturing process according to claim 17, further comprising: a selection module, wherein the selection module is configured to select the at least one of the probability based classifier and the non-probability based classifier used to compute the manufacturing process data according to the classifier accuracy rate calculated by an input signal and external data.

21. The system for analyzing variation causes of manufacturing process according to claim 17, further comprising: a coding module, wherein after acquiring the manufacturing process data, the coding module is configured to perform a numeric coding on a non-numeric variable in the manufacturing process parameters.

22. The system for analyzing variation causes of manufacturing process according to claim 21, wherein the coding module performs the numeric coding on the non-numeric variable by using a dummy variable method or an optimal scale method.

23. The system for analyzing variation causes of manufacturing process according to claim 17, wherein each of the products comprises a plurality of blocks, and the collecting module acquires the manufacturing process parameters corresponding to each of the blocks and acquires the product quality parameter corresponding to each of the products.

24. The system for analyzing variation causes of manufacturing process according to claim 23, wherein the evaluation module initializes a block quality parameter corresponding to the blocks of the products according to the product quality parameters of the products.

25. The system for analyzing variation causes of manufacturing process according to claim 24, wherein when the product quality parameter of one of the products is non-defective, the block quality parameters of the blocks in said one of the products are all non-defective.

26. The system for analyzing variation causes of manufacturing process according to claim 24, wherein when the product quality parameter of at least one of the products is defective, the block quality parameter of at least one of the blocks in said at least one of the products is defective.

27. The system for analyzing variation causes of manufacturing process according to claim 24, wherein the evaluation module further solves the non-probability based classifier having a variable selection structure,
wherein the evaluation module is further configured to check whether a classification result of classifying the product having the defective product quality parameter by the non-probability based classifier matches a data feature,
if the classification result of the non-probability based classifier does not match the data feature, the evaluation module sets the block quality parameter of at least one of the blocks in the product classified with a low reliance level as defective according to a proportion, and re-solves the non-probability based classifier having the variable selection structure.

28. The system for analyzing variation causes of manufacturing process according to claim 27, wherein if the classification result of the non-probability based classifier matches the data feature, the evaluation module is further configured to acquire the contribution rate of each of the manufacturing process parameters.

29. The system for analyzing variation causes of manufacturing process according to claim 24, wherein the evaluation module is further configured to establish a probability model for each of the product quality parameter and the block quality parameter, define a likelihood function according to the product quality parameter and the block quality parameter, define a loss function of the probability model by adding a penalty, and use an Expectation-maximization algorithm to solve and acquire the contribution rate corresponding to each of the manufacturing process parameters.

30. The system for analyzing variation causes of manufacturing process according to claim 29, wherein the probability model is established based on a logistic regression.

31. The system for analyzing variation causes of manufacturing process according to claim 17, wherein the products are divided into a plurality of groups, and the collecting module acquires the process parameters corresponding to each of the products in the groups and acquires the product quality parameter corresponding to each of the groups.

32. The system for analyzing variation causes of manufacturing process according to claim 17, wherein the collecting module acquires the manufacturing process parameters corresponding to a plurality of manufacturing time sections of each of the products and acquires the product quality parameter corresponding to each of the products.
